(19) United States
(12) Patent Application Publication
(10) Pub. No.: US 2011/0187869 A1
(43) Pub. Date: Aug. 4, 2011

(54) TRACKING-FRAME INITIAL-POSITION SETTING APPARATUS AND METHOD OF CONTROLLING OPERATION OF SAME

(75) Inventors: Hideaki KOKUBUN, Saitama-shi (JP); Masahiko Sugimoto, Saitama-shi (JP)

(73) Assignee: FUJIFILM Corporation, Tokyo (JP)

(21) Appl. No.: 12/968,099

(22) Filed: Dec. 14, 2010

(30) Foreign Application Priority Data
Jan. 29, 2010 (JP) 2010-018136

(51) Int. Cl. H04N 5/225

(52) U.S. Cl. 348/169; 348/E05.024

(57) ABSTRACT

Automatic tracking of a target image is made comparatively easy. Specifically, an image obtained by imaging a subject is displayed on a display screen and a tracking frame is displayed at a reference position located at the central portion of the display screen. A target area for setting the initial position of the tracking frame is set surrounding the tracking frame and a high-frequency-component image representing high-frequency components of the image within this area is generated. The amount of high-frequency component is calculated while a moving frame is moved within the high-frequency-component image. The position of the moving frame where the calculated amount of high-frequency component is largest is decided upon as the initial position of the tracking frame.

### BACKGROUND OF THE INVENTION

1. Field of the Invention

This invention relates to an apparatus for setting the initial position of a tracking frame in a target-image automatic tracking system, and to a method of controlling the operation of this apparatus.

2. Description of the Related Art

Digital cameras (inclusive of digital still cameras, digital movie cameras and mobile telephones incorporating a digital camera) include those capable of tracking a target image (see the specifications of Japanese Patent Application Laid-Open Nos. 5-6434 and 10-123229). By imaging persons, adopting the face image of a specific person as a target image (the image is not limited to a face image and may be the image of the person or the image of an automobile, etc.) and tracking the face image, a frame can be displayed continuously on the face image of the specific person in an image composed of a number of frames in the manner of a moving image. Imaging can performed without losing sight of the specific person.

In a case where a target image is tracked, it is necessary to set the target image. Often the setting of the target image is performed by having the user designate the target image. However, when a featureless, difficult-to-track image is designated, tracking is difficult to carry out.

### SUMMARY OF THE INVENTION

An object of the present invention is to decide the initial position of a tracking frame in such a manner that a target image is easily tracked.

The present invention provides a tracking-frame initial-position setting apparatus in a target-image automatic tracking system for inputting, in order frame by frame, image data representing a number of frames of images, and displaying, on a display screen of a display unit, a tracking frame enclosing a target image to be tracked included in the images represented by the image data that has been input, the apparatus comprising: a display control device (display control means) for controlling the display unit so as to display one image, which is represented by the image data that has been input to the target-image automatic tracking system, on the display screen, and display the tracking frame at a reference position on the display screen; a target-area setting device (target-area setting means) for setting, on the one image, a tracking-frame initial-position setting target area having a size larger than the tracking frame displayed at the reference position under the control of the display control device and smaller than the one image, the target area containing the tracking frame displayed at the reference position under the control of the display control device; a specific frequency component amount calculating device (specific frequency component amount calculating means) for moving a moving frame in the image within the initial-position setting target area that has been set by the target-area setting device, and calculating amount of high-frequency components of the image within the moving frame whenever the moving frame is moved; and a deciding device (deciding means) for deciding that a position of the moving frame where the amount of high-frequency components calculated by the specific frequency component amount calculating device exceeds a prescribed threshold value or is maximum is the initial position of the tracking frame.

The present invention also provides an operation control method suited to the tracking-frame initial-position setting apparatus described above. Specifically, the present invention provides a method of controlling operation of a tracking-frame initial-position setting apparatus in a target-image automatic tracking system for inputting, in order frame by frame, image data representing a number of frames of images, and displaying, on a display screen of a display unit, a tracking frame enclosing a target image to be tracked included in the images represented by the image data that has been input, the method comprising the steps of: controlling the display unit so as to display one image, which is represented by the image data that has been input to the target-image automatic tracking system, on the display screen, and display the tracking frame at a reference position on the display screen; setting, on the one image, a tracking-frame initial-position setting target area having a size larger than the tracking frame displayed at the reference position and smaller than the one image, the target area containing the tracking frame displayed at the reference position; moving a moving frame in the image within the initial-position setting target area that has been set, and calculating amount of high-frequency component of the image within the moving frame whenever the moving frame is moved; and deciding that a position of the moving frame where the amount of high-frequency components calculated by the specific frequency component amount calculating device exceeds a prescribed threshold value or is maximum is the initial position of the tracking frame.

In accordance with the present invention, image data representing a number of frames of images is input to an automatic tracking apparatus in order one frame at time, and one image represented by the image data that has been input to the automatic tracking apparatus is displayed on the display screen of a display unit. Further, a tracking frame is displayed at a reference position on the display screen (e.g., at the center of the display screen, although the reference position is not limited to the center). When a command to start processing for deciding the initial position of the tracking frame is applied, a tracking-frame initial-position setting target area enclosing the tracking frame is set on the one image, the target area having a size larger than the tracking frame and smaller than the one image (the display screen). A moving frame is moved within the set area and the amount of high-frequency component of the image within the moving frame is calculated whenever the moving frame is moved. The position of the moving frame where the calculated amount of high-frequency component is greater than a prescribed threshold value or is maximum is decided upon as the initial position of the tracking frame. The image at the position of the moving frame where the amount of high-frequency component is greater than a prescribed threshold value or is maximum has many edge components and is easy to track. Since this position is the initial position of the tracking frame, tracking the target image (the image within the tracking frame) with regard to images input subsequent to the one image is comparatively easy.

In a case where image data that is input to the target-image automatic tracking system is color image data, the apparatus may further comprise a color component amount calculating device (color component amount calculating means) for moving the moving frame within the image inside the initial-position setting target area that has been set by the target-area setting device, and calculating amount of component of a prescribed color component (e.g., red color component, green color component, blue color component, etc.) of the image within the moving frame whenever the moving frame is moved. In this case, the deciding device decides that the position of the moving frame where the amount of component calculated by the color component amount calculating device exceeds a prescribed threshold value or is maximum is the initial position.

The apparatus may further comprise a first control device (first control means) for controlling the specific frequency component amount calculating device so as to execute the processing for calculating the amount of high-frequency component upon enlarging the moving frame in response to the amount of high-frequency component calculated by the specific frequency component amount calculating device failing to exceed the prescribed threshold value.

The apparatus may further comprise a second control device (second control means) for controlling the color component amount calculating device so as to execute the processing for calculating the amount of color component upon enlarging the moving frame in response to the amount of color component calculated by the color component amount calculating device failing to exceed the prescribed threshold value.

The apparatus may further comprise an enlarge commanding device (enlarge commanding means) for applying a moving-frame enlargement command. In this case, the first control device controls the specific frequency component amount calculating device so as to execute the processing for calculating the amount of high-frequency component upon enlarging the moving frame in response to application of the enlargement command from the enlarge commanding device and, moreover, the amount of high-frequency component calculated by the specific frequency component amount calculating device failing to exceed the prescribed threshold value. Further, the second control means controls the color component amount calculating device so as to execute the processing for calculating the amount of color component upon enlarging the moving frame in response to application of the enlargement command from the enlarge commanding device and, moreover, the amount of color component calculated by the color component amount calculating device failing to exceed the prescribed threshold value.

The apparatus may further comprise an enlargement ratio setting device (enlargement ratio setting means) for setting an enlargement ratio of the moving frame. In this case, the first control device controls the specific frequency component amount calculating device so as to execute the processing for calculating the amount of high-frequency component upon enlarging the moving frame in accordance with the enlargement ratio, which has been set by the enlargement ratio setting device, in response to application of the enlargement command from the enlarge commanding device and, moreover, the amount of high-frequency component calculated by the specific frequency component amount calculating device failing to exceed the prescribed threshold value. Further, the second control device controls the color component amount calculating device so as to execute the processing for calculating the amount of color component upon enlarging the moving frame in accordance with the enlargement ratio, which has been set by the enlargement ratio setting device, in response to the amount of color component calculated by the color component amount calculating device failing to exceed the prescribed threshold value.

The apparatus may further comprise a third control device (third control means) for controlling the specific frequency component amount calculating device so as to execute the processing for calculating the amount of high-frequency component upon reducing the size of the one image in response to the amount of high-frequency component calculated by the specific frequency component amount calculating device failing to exceed the prescribed threshold value.

The apparatus may further comprise a fourth control device (fourth control means) for controlling the color component amount calculating device so as to execute the processing for calculating the amount of color component upon reducing the size of the one image in response to the amount of color component calculated by the color component amount calculating device failing to exceed the prescribed threshold value.

The apparatus may further comprise a first notification device (first notification means) for giving notification that tracking processing cannot be executed in response to the amount of high-frequency component calculated by the specific frequency component amount calculating device failing to exceed the prescribed threshold value.

The apparatus may further comprise a second notification device (second notification means) for giving notification that tracking processing cannot be executed in response to the amount of color component calculated by the color component amount calculating device failing to exceed the prescribed threshold value.

The first notification device may give notification that tracking processing cannot be executed by a voice output or a change in form of the display of the tracking frame. Alternatively, the first notification device may give notification that tracking processing cannot be executed by a change in the color, type of line or shape of the tracking frame, or by a change in method of lighting or flashing the tracking frame.

The second notification device may give notification that tracking processing cannot be executed by a voice output or by a change in form of the display of the tracking frame. Alternatively, the first notification device may give notification that tracking processing cannot be executed by the color, type of line or shape of the tracking frame, or by a change in method of lighting or extinguishing the tracking frame.

The target-area setting device sets the tracking-frame initial-position setting target area on the one image in such a manner that the reference position will be at the center. In this case, the specific frequency component amount calculating device moves the moving frame outward from the reference position and calculates the amount of high-frequency component of the image within the moving frame whenever the moving frame is moved.

The target-area setting device sets the tracking-frame initial-position setting target area on the one image in such a manner that the reference position will be at the center. In this case, the color component amount calculating device moves the moving frame outward from the reference position and calculates the amount of component of the prescribed color component of the image within the moving frame whenever the moving frame is moved.

The specific frequency component amount calculating device moves the moving frame and calculates amount of low-frequency component, or amount of intermediate-frequency component from which high-frequency components have been eliminated, of the image within the moving frame whenever the moving frame is moved, and the deciding device decides that a position of the moving frame where the amount of low-frequency component or amount of intermediate-frequency component calculated by the specific frequency component amount calculating device exceeds a prescribed threshold value is the initial position of the tracking frame.

The apparatus may further comprise a noise reduction processing device (noise reduction processing means) for applying noise reduction processing to image data representing the one image. In this case, the one image represented by the image data that has been subjected to the noise reduction processing by the noise reduction processing device would be subjected to processing by the target-area setting device, processing by the specific frequency component amount calculating device and processing by the deciding device. For example, since it is considered that an image having a brightness of less than 100 lux would contain a large amount of noise, this image would be subjected to noise reduction processing.

The apparatus may further comprise a signal processing device (signal processing means) for applying false-color or false-signal reduction processing to the image data representing the one image. In this case, the one image represented by the image data that has been subjected to the false-color or false-signal reduction processing by the signal processing device would be subjected to processing by the target-area setting device, processing by the specific frequency component amount calculating device and processing by the deciding device.

The apparatus may further comprise a halt commanding device (halt commanding means) for applying a command that halts processing for deciding the initial position of the tracking frame. In this case, in response to application of the halt command from the halt commanding device, processing by the target-area setting device, processing by the specific frequency component amount calculating device and processing by the deciding device is halted and the reference position is decided upon as the initial position of the tracking frame.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical configuration of a digital still camera;

FIG. 2 is a flowchart illustrating processing for setting the initial position of a tracking frame;

FIGS. 3 to 7 illustrate an example of an image of a subject;

FIG. 8 is a flowchart illustrating processing for setting the initial position of a tracking frame;

FIGS. 9 to 11 are examples of color component histograms;

FIG. 12 is a flowchart illustrating processing for setting the initial position of a tracking frame;

FIG. 13 is an example of a menu image for setting an initial position of a tracking frame;

FIG. 14 is a flowchart illustrating processing for setting the initial position of a tracking frame;

FIGS. 15 to 17 illustrate an example of an image of a subject;

FIG. 18 is a flowchart illustrating processing for setting the initial position of a tracking frame;

FIG. 19 is an example of a menu image of a method of setting the initial position of a tracking frame;

FIG. 20 is a flowchart illustrating processing for setting the initial position of a tracking frame;

FIG. 21 is an example of a menu image for enlarging a tracking frame;

FIGS. 22 and 23 are flowcharts illustrating processing for setting the initial position of a tracking frame;

FIG. 24 is an example of an image of a subject;

FIGS. 25 and 26 are flowcharts illustrating processing for setting the initial position of a tracking frame;

FIG. 27 is an example of an image of a subject;

FIG. 28 is a flowchart illustrating processing for calculating amount of high-frequency components;

FIGS. 29A to 29C illustrate the manner in which a moving frame is moved;

FIG. 30 illustrates RGB color space; and

FIG. 31 illustrates distributions of pixels.

### DESCRIPTION OF THE PREFERRED EMBODIMENTS

Preferred embodiments of the present invention will now be described in detail with reference to the drawings.

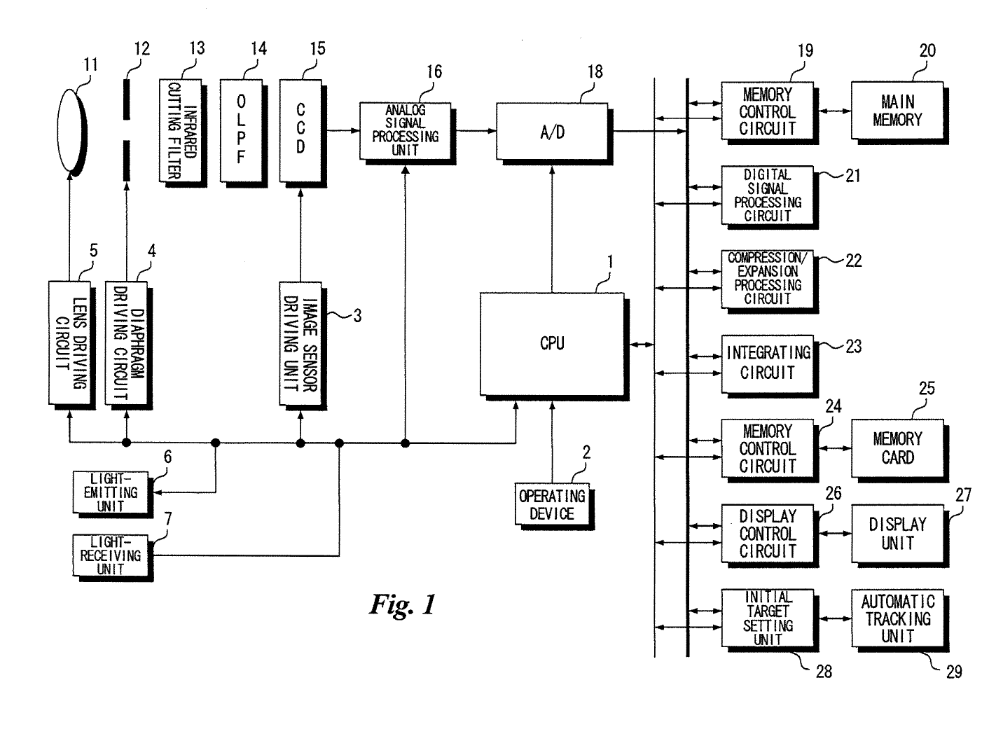

FIG. 1 is a block diagram illustrating the electrical configuration of a digital still camera according to an embodiment of the present invention. It goes without saying that embodiments of the present invention are not limited to a digital still camera but are also applicable to a digital movie camera.

The overall operation of the digital still camera is controlled by a CPU 1.

The digital still camera includes an operating device 2. The operating device 2 includes a power button, a mode setting dial and a two-step stroke-type shutter-release button, etc. An operation signal that is output from the operating device 2 is input to the CPU 1. Modes set by the mode setting dial include a shooting mode, a playback mode, etc.

The digital still camera is provided with a light-emitting unit 6 for electronic flash photography, and a light-receiving unit 7 for receiving reflected light resulting from a light emission from the light-emitting unit 6.

An imaging lens 11, diaphragm 12, infrared cutting filter 13 and an optical low-pass filter 14 are provided in front of a CCD 15. The imaging lens 11 is positioned by a lens driving circuit 5 and the aperture of the diaphragm 12 is controlled by a diaphragm driving circuit 4.

When the shooting mode is set, light rays representing the image of a subject are collected by the imaging lens 11 and impinge upon the photoreceptor surface of the CCD 15 via the infrared cutting filter 13 and optical low-pass filter 14. The image of the subject is formed on the photoreceptor surface of the CCD 15 and an analog video signal representing the image of the subject is output from the CCD 15. Thus, the subject is imaged at a fixed period by the CCD 15 and a video signal representing the image of the subject at the fixed period is output from the CCD 15 one frame at a time.

An analog signal processing unit 16 includes a correlated double sampling circuit and a signal amplifying circuit, etc. An analog video signal that has been output from the CCD 15 is input to the analog signal processing unit 16 and is subjected to correlated double sampling and signal amplification. The analog signal that has been output from the analog signal processing unit 16 is input to an analog/digital converting circuit 18 and is converted to a digital image signal. The digital image data obtained by the conversion is stored temporarily in a main memory 20 under the control of a memory control circuit 19.

The image data is read out of the main memory 20 and is input to a digital signal processing circuit 21. The digital signal processing circuit 21 executes prescribed digital signal processing such as a white balance adjustment and a gamma correction. The image data that has been subjected to digital signal processing in the digital signal processing circuit 21 is applied to a display control circuit 26. A display unit 27 is controlled by the display control circuit 26, whereby the image of the subject obtained by imaging is displayed on the display screen of the display unit 27.

If the shutter-release button is pressed through the first step of its stroke, the image data that has been output from the analog/digital converting circuit 18 is recorded in the main memory 20 in the manner described above. The image data that has been read out of the main memory 20 is converted to luminance data in the digital signal processing circuit 21. The luminance data obtained by the conversion is input to an integrating circuit 23 and is integrated. Data representing the integrated value is applied to the CPU 1 and the amount of exposure is calculated. The aperture of the diaphragm 12 and the shutter speed of the CCD 15 are controlled in such a manner that the calculated amount of exposure is attained.

If the shutter-release button is pressed through the second step of its stroke, the image data that has been output from the analog/digital converting circuit 18 is similarly recorded in the main memory 20. The image data that has been read out of the main memory 20 is subjected to digital signal processing in the digital signal processing circuit 21 in a manner similar to that described above. The image data that has been output from the digital signal processing circuit 21 is subjected to data compression in a compression/expansion processing circuit 22. The image data that has been compressed is recorded on a memory card 25 by control performed by an external-memory control circuit 24.

In this embodiment, a target image contained in the image of a subject can be tracked automatically. By performing automatic tracking, a frame (a tracking frame) can be displayed continuously on a target image contained in a subject image (a moving image) obtained continuously by shooting. Thus shooting can be repeated without losing sight of a specific person. Further, an exposure adjustment can be performed in such a manner that the target image will take on an appropriate brightness, and a focus adjustment can be performed so as to bring the target image into focus.

In a case where the target image is tracked, it is necessary to set the target image (initial target setting). This embodiment is such that if part of the target image is designated by the user, a tracking frame is decided using an easy-to-track portion in the vicinity of the designated part as the target image. Tracking thus becomes comparatively easy.

In order to decide the initial position of the tracking frame, the digital still camera includes an initial target setting unit 28. A tracking frame set by the initial target setting unit 28 is displayed on the display screen of the display unit 27. The image within the tracking frame set by the initial target setting unit 28 is adopted as the target image and the target image is tracked by an automatic tracking unit 29.

When the playback mode is set, the compressed image data that has been recorded on the memory card 25 is read. The compressed image data read is expanded in the compression/expansion processing circuit 22. By applying the expanded image data to the display control circuit 26, the reproduced image is displayed on the display screen of the display unit 27. It may be so arranged that the above-described automatic tracking is performed not only at the time of recording but also at playback.

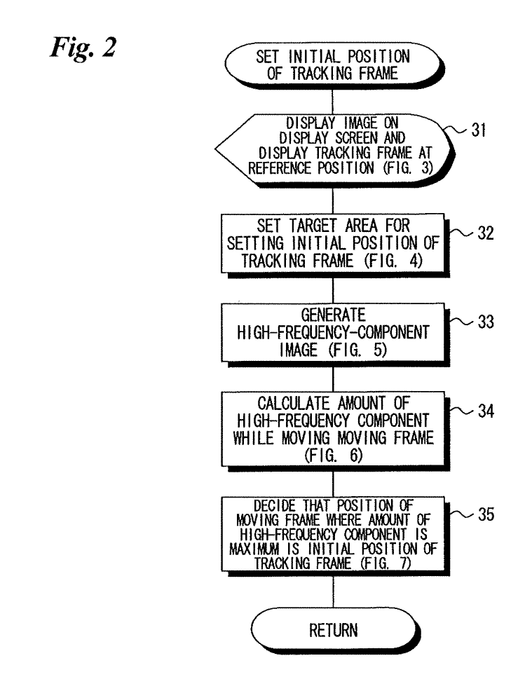

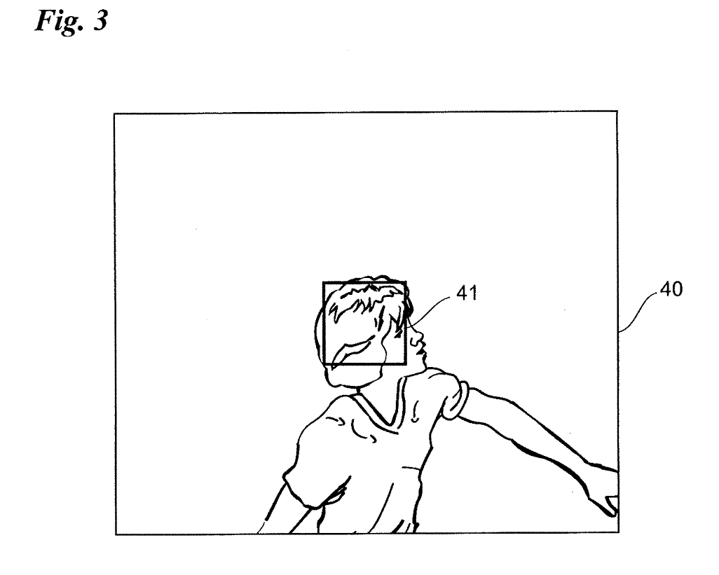

FIG. 2 is a flowchart illustrating processing for setting the initial position of the tracking frame. FIGS. 3 to 7 illustrate an example of an image displayed on the display screen of the display unit 27. An image 40 shown in FIGS. 3 to 7 is one image among a number of frames of images obtained by shooting a subject continuously at a fixed period by setting the shooting mode as described above.

When the shooting mode is set, a subject is imaged at a fixed period and the image of the subject is displayed as a moving image (a so-called “through-the-lens image”) on the display screen of the display unit 27 as described above. A tracking frame 41 is displayed at a reference position, which is the central portion of the display screen of the display unit 27 (step 31). (The reference position need not necessarily be the central portion, and there may be a plurality thereof.)

FIG. 3 illustrates the manner in which the tracking frame 41 is displayed at the reference position.

The one image 40 obtained by imaging the subject is being displayed on the display screen of the display unit 27. The tracking frame 41, which is a rectangle of a prescribed size, is being displayed on the reference position located at the central portion of the display screen. The shape of the tracking frame 41 is not limited to a rectangle and may be of any shape. Further, a person, a face or the like may be recognized and the shape of the person or face recognized may be adopted as the tracking frame.

The photographer decides the camera angle in such a manner that the target image desired to be tracked falls within the tracking frame 41. If at least a portion of the target image falls within the tracking frame 41, the photographer presses the shutter-release button through the first step of its stroke (i.e., applies a command that starts processing for deciding the initial position of the tracking frame). When this is done, a target area for setting the initial position of the tracking frame is set outside the tracking frame 41 (step 32 in FIG. 2). Naturally, it may be so arranged that the processing of step 31 for displaying the tracking frame is executed by pressing the shutter-release button through the first step of its stroke. Further, the command for starting processing for deciding the initial position of the tracking frame may be applied to the digital still camera from another special-purpose button or switch rather than by pressing the shutter-release button through the first step of its stroke.

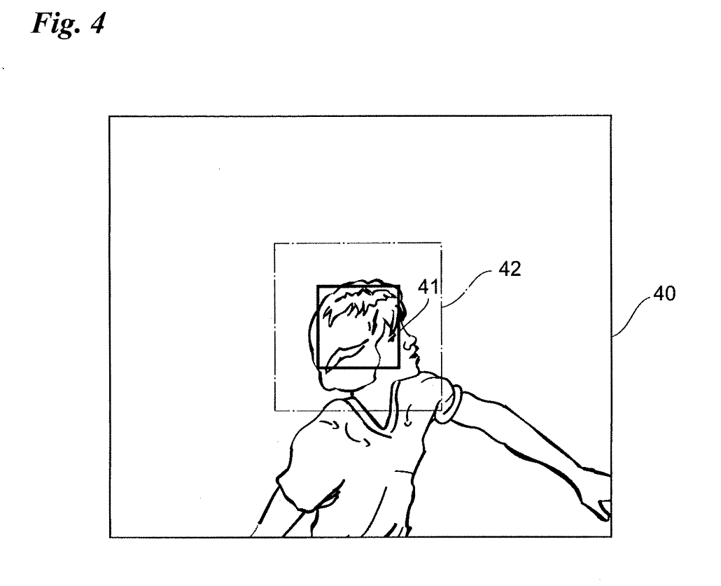

FIG. 4 illustrates how a target area 42 for setting the initial position of the tracking frame has been set on the image 40.

The target area 42 for setting the initial position of the tracking frame has a size larger than that of the tracking frame 41 and smaller than that of the image (display screen) 40, and it contains the tracking frame 41. In FIG. 4, a phantom line is indicated so that the target area 42 can be understood. However, the target area 42 need not necessarily be displayed on the display screen.

When the target area 42 for setting the initial position of the tracking frame is set, a high-frequency-component image is generated by extracting high-frequency components of the target image contained in the target area 42 (step 33 in FIG. 2).

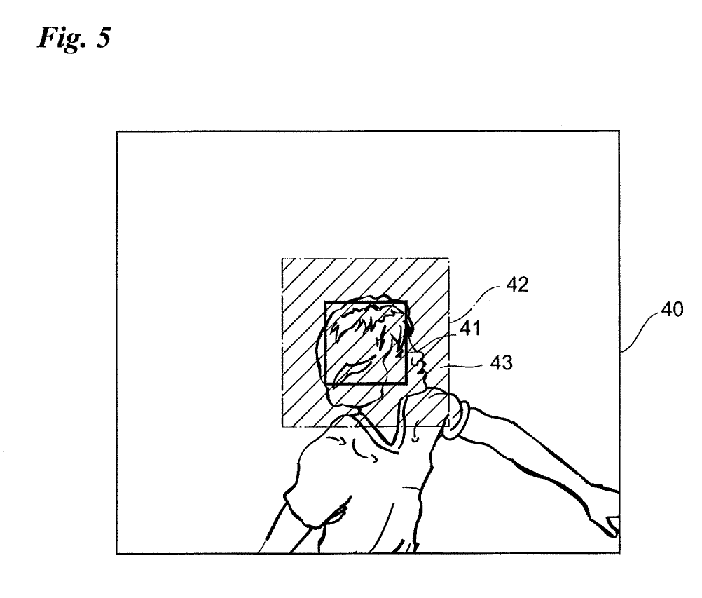

FIG. 5 illustrates the manner in which high-frequency components have been extracted from the image contained in the target area 42 to thereby generate a high-frequency-component image 43.

The high-frequency-component image 43 thus generated by extracting high-frequency components from the image within the area 42 is displayed within the area 42. In order to indicate that the image within the area 42 is the image 43 composed of high-frequency components, the image 43 is hatched.

A moving frame having the same shape and size as those of the tracking frame 41 is set within the high-frequency-component image 43 generated. The amount of high-frequency component is calculated while the moving frame is moved one pixel at a time horizontally and vertically within the high-frequency-component image 43 (step 34 in FIG. 2).

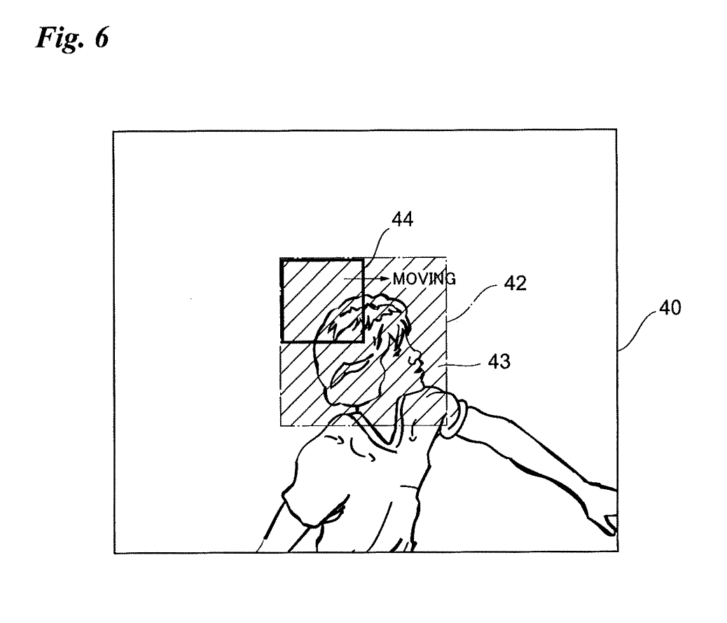

FIG. 6 illustrate the manner in which a moving frame 44 is being displayed.

As mentioned above, the moving frame 44, which has the same shape as that of the tracking frame 41 (although the shape need not be the same) and the same size (although the size need not be the same), is set within the high-frequency-component image 43. The moving frame 44 may or may not be displayed. The moving frame 44 is moved one pixel at a time horizontally and vertically within the high-frequency-component image 43 and, for every position to which the moving frame 44 is moved, a count is taken of the number of pixels, from among the pixels contained in the moving frame, having high-frequency components greater than a prescribed threshold value, thereby calculating the amount of high-frequency component (the value of the count).

The position of the moving frame 44 where the amount of high-frequency component is maximum is decided upon as the initial position of the tracking frame 41 (step 35 in FIG. 2).

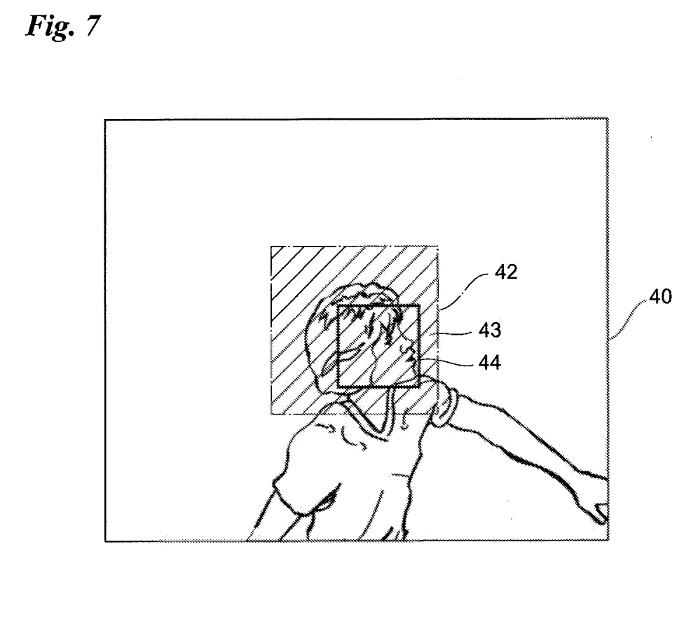

FIG. 7 illustrates how the initial position of the tracking frame 41 is decided.

In a case where the amount of high-frequency component has been calculated while moving the moving frame 44 within the area 42 in the manner described above, it is assumed that the amount of high-frequency component will be maximum when the moving frame 44 is at the position of the moving frame 44 shown in FIG. 7. When this occurs, the position of the moving frame 44 at this time is decided upon as the initial position of the tracking frame 41.

When the initial position of the tracking frame 41 is thus decided, the image within the tracking frame 41 is adopted as the target image and tracking processing starts, from this initial position, with regard to the image that is input one image later. The image within the tracking frame 41 decided as the initial position has the maximum amount of high-frequency component in the area 42, and the image contains many edges. Tracking processing, therefore is comparatively easy. The image within the tracking frame 41 used in tracking processing may be the image having the extracted high-frequency components or may be the image 40 before the extraction of the high-frequency components.

It goes without saying that the generation of the high-frequency-component image may be performed by including a high-pass filter in the initial-target setting unit and using this high-pass filter to generate the high-frequency-component image. Naturally, some or all of the above-described processing may be executed using hardware, or some or all of the processing may be executed using software.

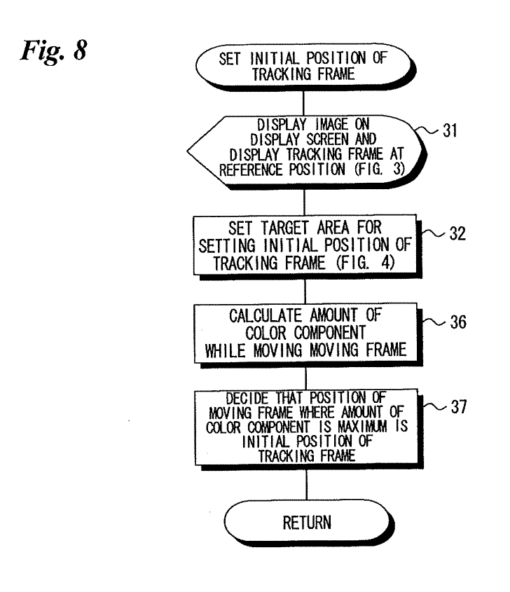

FIG. 8 is a flowchart illustrating processing for setting the initial position of the tracking frame according to another embodiment of the present invention. FIG. 8 corresponds to FIG. 2, and processing steps shown in FIG. 8 identical with those shown in FIG. 2 are designated by like step numbers and need not be described again.

In the embodiment described above, the position of the moving frame 44 where the amount of high-frequency component is maximum within the target area 42 for setting the initial position of the tracking frame is adopted as the initial position of the tracking frame 41. In the processing shown in FIG. 8, however, the position of the moving frame 44 where the amount of a color component is maximum is adopted as the initial position of the tracking frame 41.

The target area 42 for setting the initial position of the tracking frame is set (step 32), as described above, and the moving frame 44 is moved one pixel at a time horizontally and vertically within the area 42 (step 36). At every position to which the moving frame 44 is moved, numbers of pixels (amounts of color component), which are greater than a threshold value, of the color components of the pixels constituting the image present within the moving frame 44 are calculated (step 36). (The color components are red, green and blue color components. However, the color components may be of other three primary colors such as cyan, magenta and yellow, color differences such as Cr and Cb, or other color components). The position of the moving frame 44 where the calculated amount of color component is maximum is adopted as the initial position of the tracking frame 41 (step 37).

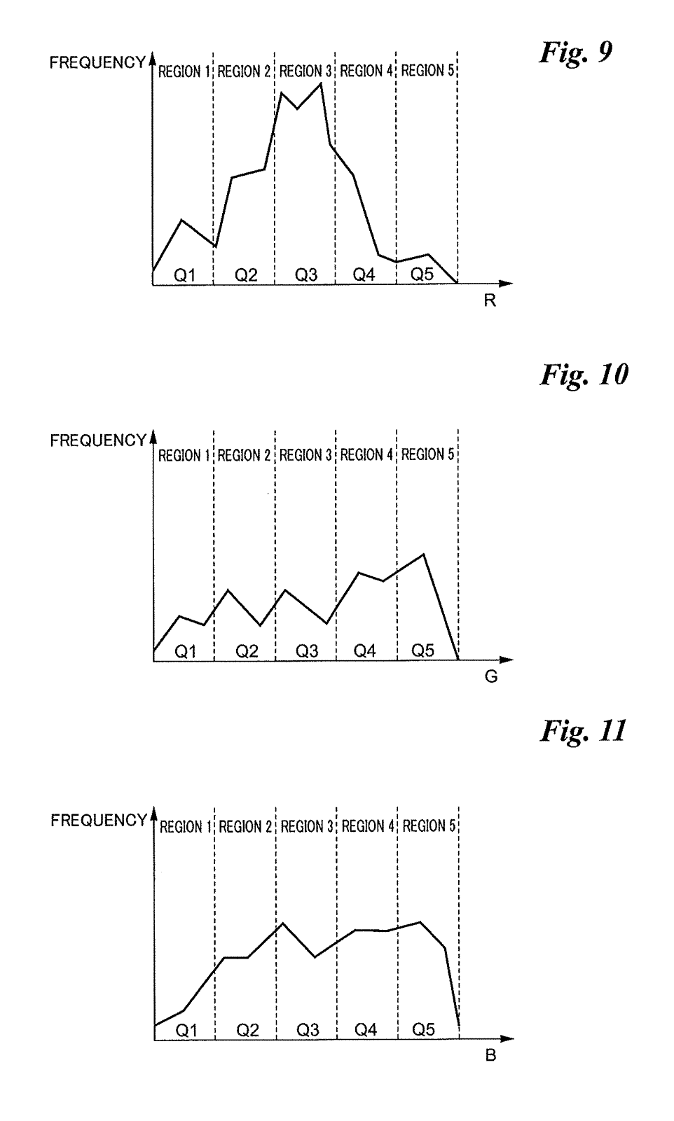

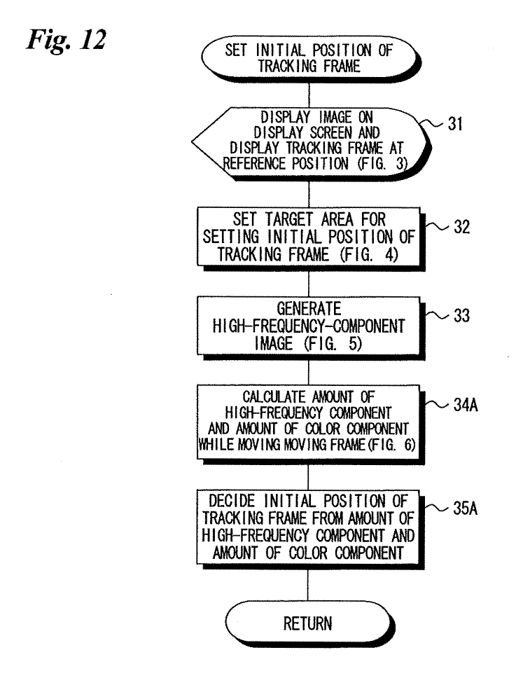

FIGS. 9 to 11 are examples of color component histograms. FIG. 9 is a color component histogram of the red color component, FIG. 10 a color component histogram of the green color component and FIG. 11 a color component histogram of the blue color component.

It is assumed in FIG. 9 that amounts Q1 to Q5 of the red color component have been calculated in respective ones of five regions 1 to 5 to which the moving frame 44 has been moved. (Since the moving frame 44 is actually moved one pixel at a time, amounts of the red color component are obtained at many more locations to which the moving frame 44 is moved. For the sake of convenience, however, it is assumed here that the amounts of the color component have been obtained with regard to five locations.)

Similarly, it is assumed in FIG. 10 that amounts Q6 to Q10 of the green color component have been calculated in respective ones of the five regions 1 to 5 to which the moving frame 44 has been moved, and it is assumed in FIG. 11 that amounts Q11 to Q15 of the blue color component have been calculated in respective ones of five regions 1 to 5 to which the moving frame 44 has been moved.

Among these amounts Q1 to Q5 of the red color component, amounts Q6 to Q10 of the green color component and amounts Q11 to Q15 of the blue color component, the position of the moving frame 44 where the amount of color component is maximum is adopted as the initial position of the tracking frame 41. For example, in a case where the amount Q3 of red color component is maximum, the position in region 3 becomes the initial position of the tracking frame 41. Naturally, the position of the moving frame 44 where the amount of color component is maximum from among the amounts Q1 to Q5 of the red color component, amounts Q6 to Q10 of the green color component and amounts Q11 to Q15 of the blue color component need not be adopted as the initial position of the tracking frame 41. Rather, the color components of the target image designated by the photographer may be analyzed and the position of the moving frame 44 where the amount of component of the color component the same as or close to the prevalent color component among the color components contained in the target image is maximum may be adopted as the initial position of the tracking frame 41.

FIG. 12 is a flowchart illustrating processing for setting the initial position of the tracking frame according to a modification. Processing steps shown in FIG. 12 identical with those shown in FIG. 8 are designated by like step numbers and need not be described again.

In the processing shown in FIG. 8, the position of the moving frame 41 where the amount of color component is maximum is adopted as the initial position of the tracking frame 44. With the processing shown in FIG. 12, however, the initial position of the tracking frame 44 is decided using both the amount of high-frequency components and the amount of color components.

A high-frequency-component image is generated from the image within the target area 42 for setting the initial position of the tracking frame (step 33), as described above. Then, while the moving frame 41 is being moved, the amount of high-frequency component and the amount of color component are calculated at every position to which the moving frame 41 is moved (step 34A). The initial position of the tracking frame is decided from the calculated amount of high-frequency components and calculated amount of color components (step 35A).

By way of example, the overall amount of component is calculated in accordance with Equation (1) below at every position to which the moving frame 44 is moved. The position of the moving frame 44 where the overall amount of component is maximum is adopted as the initial position of the tracking frame 41. In Equation (1), w represents a weighting coefficient, e.g., 0.5.

overall amount of component=w×(amount of high-frequency component)+(1−w)(amount of color component) Eq. (1)

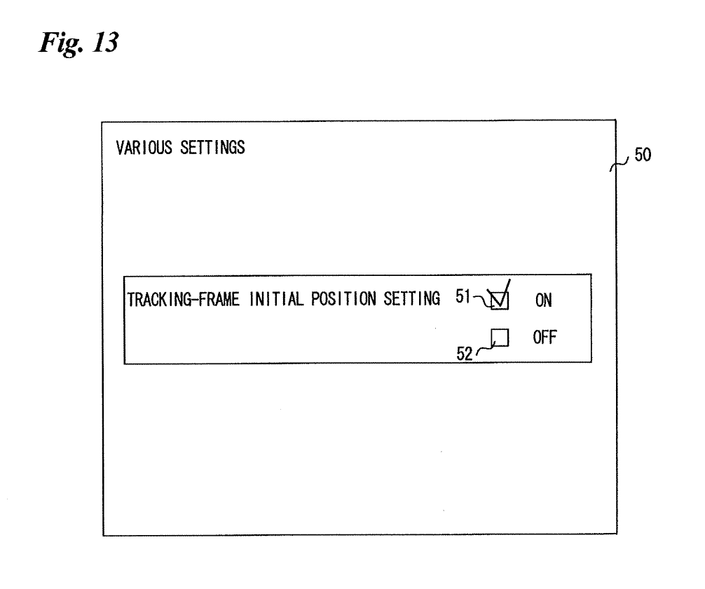

FIG. 13 is an example of a menu image for setting an initial position of a tracking frame.

If a menu mode is set using a mode setting button on the digital still camera and a menu for setting the initial position of the tracking frame is selected from within the menu mode, a menu image 50 (FIG. 13) for setting the initial position of the tracking frame is displayed on the display screen of the display unit 27.

A character string reading “TRACKING-FRAME INITIAL POSITION SETTING” is displayed substantially at the center of the menu image 50 for setting the initial position of the tracking frame. A first check box 51 and a second check box 52 are displayed to the right of this character string. Characters reading “ON” are displayed to the right of the first check box 51, and characters reading “OFF” are displayed to the right of the second check box 52. The operating device 2 includes an up, down, left, right button for moving a cursor up, down, left and right. Inputting an UP command from the button places a check in the first check box 51, and inputting a DOWN command from the button places a check in the second check box 52.

If the first check box 51 is checked, the digital still camera is set in such a manner that the setting of the initial position of the tracking frame will be carried out in the manner described above. If the second check box 52 is checked, then the digital still camera is set in such a manner that the setting of the initial position of the tracking frame will not be carried out. If the setting of the initial position of the tracking frame is not carried out, automatic tracking processing is executed with the reference position, which is the central portion of the display screen, serving as the initial position of the tracking frame, as set forth earlier.

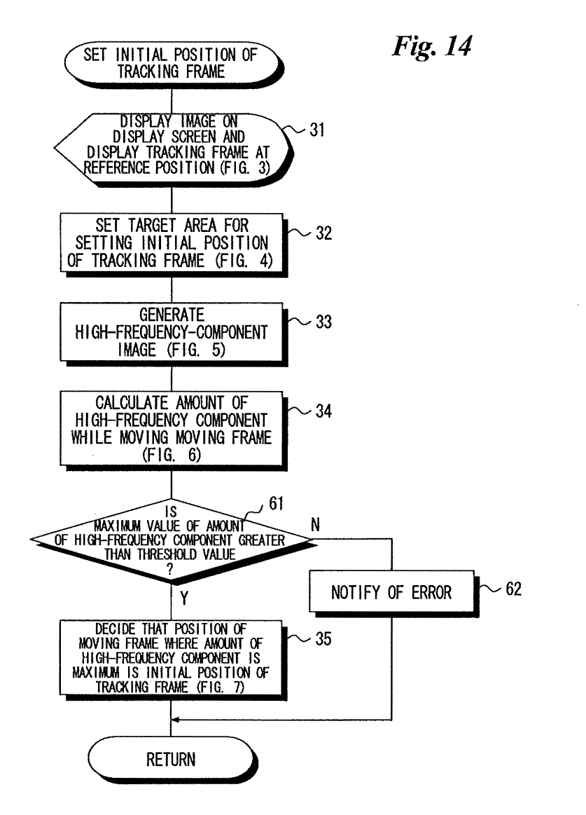

FIGS. 14 to 16 illustrate another embodiment of the present invention. FIG. 14 is a flowchart illustrating processing for setting the initial position of the tracking frame 44. Processing steps shown in FIG. 14 identical with those shown in FIG. 2 are designated by like step numbers and need not be described again.

The moving frame 41 is moved within the target area 42 for setting the initial position of the tracking frame and the amount of high-frequency component calculated at every position to which the moving frame is moved (step 34). It is determined whether the maximum value of the amount of high-frequency component obtained greater than a prescribed threshold value (step 61). If the maximum value is greater than the threshold value (“YES” at step 61), the position of the moving frame 41 where the amount of high-frequency components is maximum is decided upon as the initial position of the tracking frame 44 (step 35). If the maximum value is not greater than the threshold value (“NO” at step 61), then an error notification is given (step 62).

The error notification may be an output of an error tone or a display indicative of an error. Alternatively, the error notification may be made by presenting the display of the tracking frame 44 in a form different from that in a case where the initial position has been decided. For example, the color of the tracking frame may be changed. Alternatively, the error notification may be made by making the lighting or flashing of the tracking frame different from that in a case where the initial position of the tracking frame 44 has been decided.

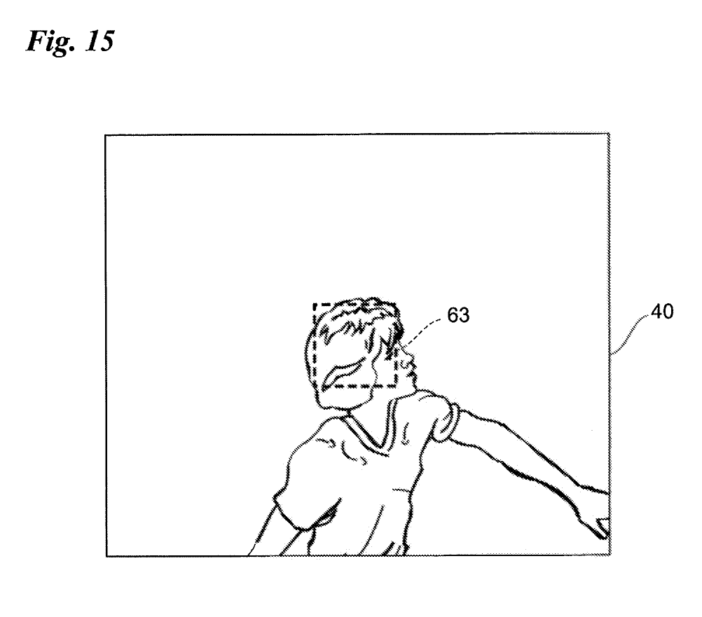

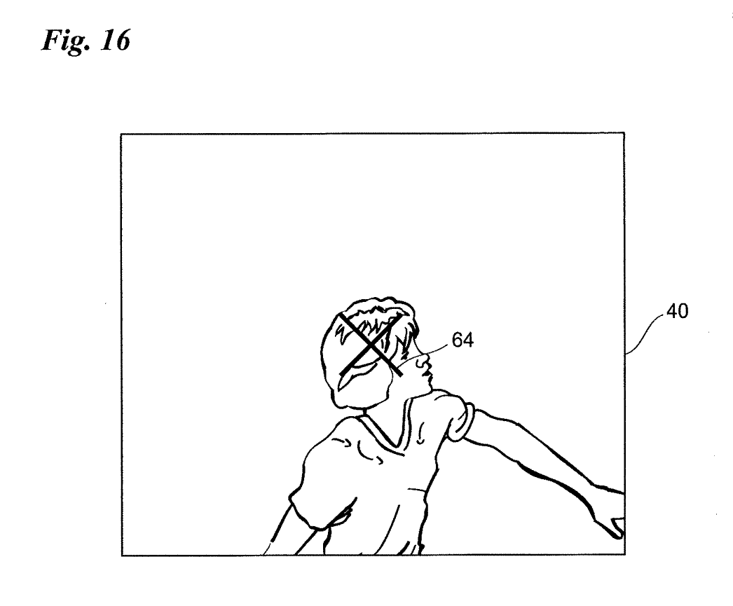

FIGS. 15 and 16 are an example of an image displayed on the display screen in a case where error notification is given.

In FIG. 15, a frame 63 for an error display is being displayed at the central portion of the image 40. The frame 63 is a broken line whereas tracking frame 44 is a solid line. By displaying the broken-line frame 63, the photographer can ascertain that an error has occurred.

In FIG. 16, an X-mark 64 for an error display is being displayed at the central portion of the image 40. By displaying the X-mark 64, the photographer can ascertain that an error has occurred.

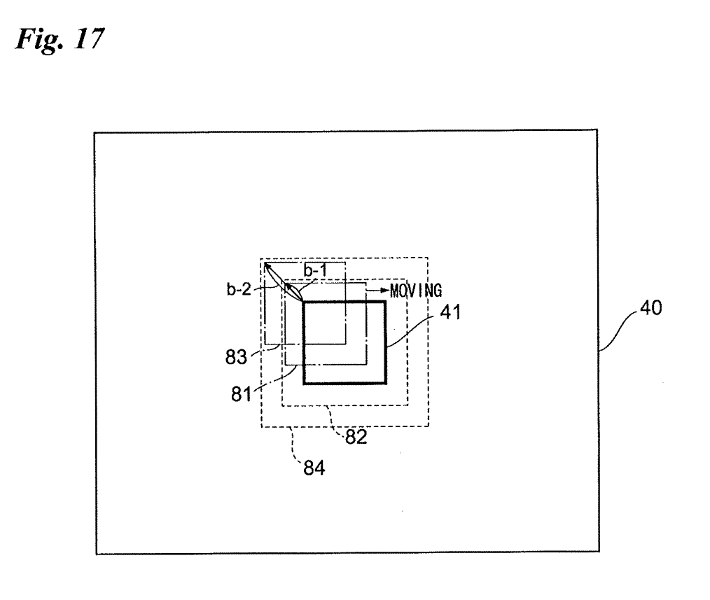

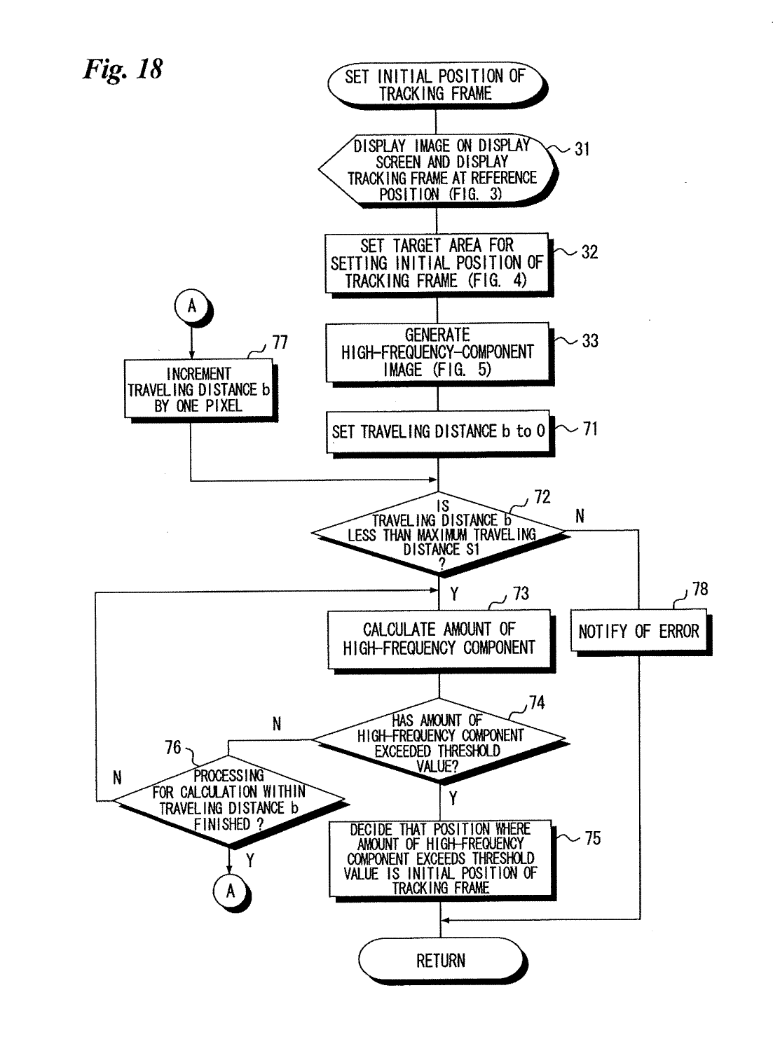

FIGS. 17 and 18 illustrate another embodiment.

FIG. 17 illustrates how moving frame 41 is moved.

In the foregoing embodiments, the movement of the moving frame 41 is arbitrary (usually the moving frame 41 would be moved rightward from the upper left and downward line by line in the manner of a television scan). In this embodiment, however, the moving frame 41 is moved outward from the reference position at the central portion of the image 40.

First, the amount of high-frequency component is calculated within the moving frame 41 at the reference position. If the amount of high-frequency component calculated does not exceed a threshold value, the moving frame 41 is moved to the upper left by one pixel (a traveling distance b=1) (position 81 in FIG. 17). The amount of high-frequency component is calculated within the moving frame 41 at the position 81. If the amount of high-frequency component calculated does not exceed the threshold value, the moving frame 41 is moved rightward from the position 81 by one pixel and the amount of high-frequency component is calculated. The movement of the moving frame 41 and the calculation of amount of high-frequency component at each position to which the frame is moved are repeated in similar fashion until the amount of high-frequency component exceeds the prescribed threshold value in an area 82 obtained by outwardly widening, by one pixel vertically and horizontally, the moving frame 41 in the case where the moving frame 41 is present at the reference position at the central portion of image 40.

If the amount of high-frequency component in area 82 widened by one pixel vertically and horizontally does not exceed the prescribed threshold value, then the moving frame 41 is moved further to the upper left by one pixel (a traveling distance b which is a total of 2) to a position 83, and the amount of high-frequency component at this position is calculated. Similarly, the moving frame 41 is moved one pixel vertically and horizontally until the amount of high-frequency component exceeds the threshold value, and the movement of the moving frame 41 and the calculation of amount of high-frequency component at each position to which the frame is moved are repeated in similar fashion until the amount of high-frequency component exceeds the prescribed threshold value in an area 84 obtained by outwardly widening, by two pixels vertically and horizontally, the moving frame 41 in the case where the moving frame 41 is present at the reference position at the central portion of the image 40.

Thus, the moving frame 41 is moved outward from the central position of the image 40 and the amount of high-frequency component is calculated.

FIG. 18 is a flowchart illustrating processing for setting the initial position of the tracking frame. Processing steps shown in FIG. 18 identical with those shown in FIG. 2 are designated by like step numbers and need not be described again.

High-frequency components are generated, as mentioned above, and the traveling distance b is set to 0 (step 71). It is determined whether the set traveling distance b is less than a maximum traveling distance S1 (step 72). The maximum traveling distance S1 is one-half the length of either the long side or short side of the image 40 (display screen). The maximum traveling distance S1 may be obtained by subtracting a length which is one-half the length of the diagonal of the moving frame 41 from a length which is one-half the length of the diagonal of the image 40.

If the traveling distance b is equal to or greater than the maximum traveling distance S1 (“NO” at step 72), notification of an error is given (step 78). If the traveling distance b is less than the maximum traveling distance S1 (“YES” at step 72), then, as described above, the amount of high-frequency component within the moving frame 41 at the reference position is calculated (step 73). If the amount of high-frequency component calculated does not exceed the prescribed threshold value (“NO” at step 74), then whether processing for the calculation within the traveling distance b has ended is determined (step 76). If the traveling distance b is zero, the moving frame 41 is not moved. The traveling distance b is therefore incremented by one (“YES” at step 76; step 77).

When the traveling distance b becomes 1, the amount of high-frequency component within the area 82 is calculated until the amount of high-frequency component exceeds the threshold value, as mentioned above. If the amount of high-frequency component calculated within the area 82 does not exceed the prescribed threshold value, the traveling distance b is incremented further and the amount of high-frequency component within the area 84 is calculated. The position of the moving frame 41 prevailing when the amount of high-frequency component exceeds the threshold value is decided upon as the initial position of the tracking frame (step 75).

Since it is not necessarily required to execute processing for calculating the amount of high-frequency component with regard to the entirety of the target area 42 for setting the initial position of the tracking frame, the time it takes to decide the tracking frame can be shortened.

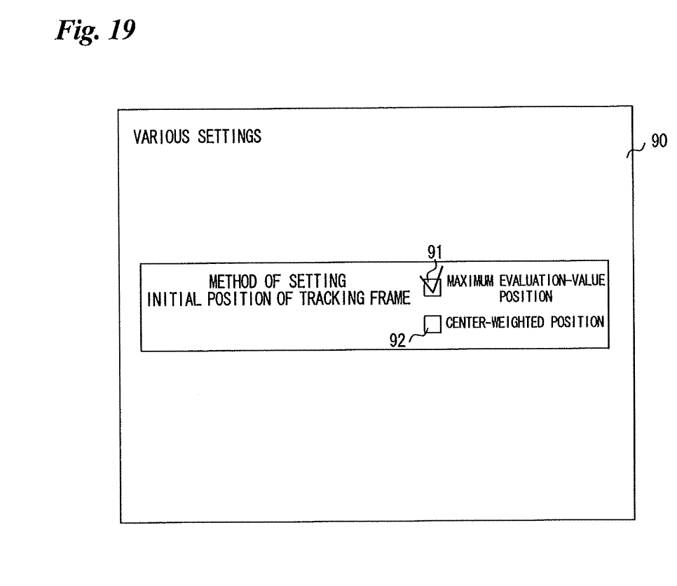

FIG. 19 is an example of a menu image of a method of setting the initial position of a tracking frame.

If the menu mode is set using the mode setting button on the digital still camera and a menu of a method of setting the initial position of a tracking frame is selected from within the menu mode, a menu image 90 (FIG. 19) of a method of setting the initial position of the tracking frame is displayed on the display screen of the display unit 27.

A character string reading “METHOD OF SETTING INITIAL POSITION OF TRACKING FRAME” is displayed substantially at the center of the menu image 90 of the method of setting the initial position of the tracking frame. A first check box 91 and a second check box 92 are displayed to the right of this character string. Characters reading “MAXIMUM EVALUATION-VALUE POSITION” are displayed to the right of the first check box 91, and characters reading “CENTER-WEIGHTED POSITION” are displayed to the right of the second check box 92. Inputting an UP command from the up, down, left, right button places a check in the first check box 91, and inputting a DOWN command from the up, down, left, right button places a check in the second check box 92.

If the first check box 91 is checked, the above-described processing for calculating the amount of high-frequency component is executed within the entirety of the target area 42 for setting the initial position of the tracking frame, and the position at which the maximum amount of high-frequency component is obtained is decided upon as the initial position of the tracking frame. On the other hand, if the second check box 92 is checked, then, as described above, the moving frame 41 is moved sequentially outward from the reference position and the position of the moving frame 41 prevailing when the amount of high-frequency component obtained with each movement first exceeds the prescribed threshold value is decided upon as the initial position of the tracking frame.

FIG. 20 is a flowchart illustrating processing for setting the initial position of a tracking frame. Processing steps shown in FIG. 20 identical with those shown in FIG. 18 are designated by like step numbers and need not be described again.

When the moving frame 41 is moved and the amount of high-frequency component is calculated at the position to which the moving frame is moved, it is determined whether the amount of high-frequency component calculated has exceeded the threshold value (step 74), as described above. If the threshold value is exceeded (“YES” at step 74), then, if the amount of high-frequency component calculated is larger than the maximum value of the amount of high-frequency component calculated thus far, the maximum value is updated (step 79).

If the center-weighted position has been set in the method of setting the initial position of the tracking frame (i.e., if center weighting has been set), as described above (“YES” at step 80), the position of the moving frame 41 where the amount of high-frequency component exceeded the threshold value the first time is decided upon as the initial position of the tracking frame (step 75). In the case where the center-weighted position has been set, a position near the center of the image 40 is decided upon as the initial position. Since it is considered that the portion the photographer assumes to be the target image is the center of the image and since the position that will be decided upon as the initial position of the tracking frame 44 is near the center, the photographer can be prevented from experiencing a feeling of incongruity. If the center-weighted position has not been set in the method of setting the initial position of the tracking frame (i.e., if center weighting has not been set) (“NO” at step 80), then the processing for calculating the amount of high-frequency component at all positions within the target area 42 for setting the initial position of the tracking frame is repeated even though the amount of high-frequency component exceeds the threshold value (step 76).

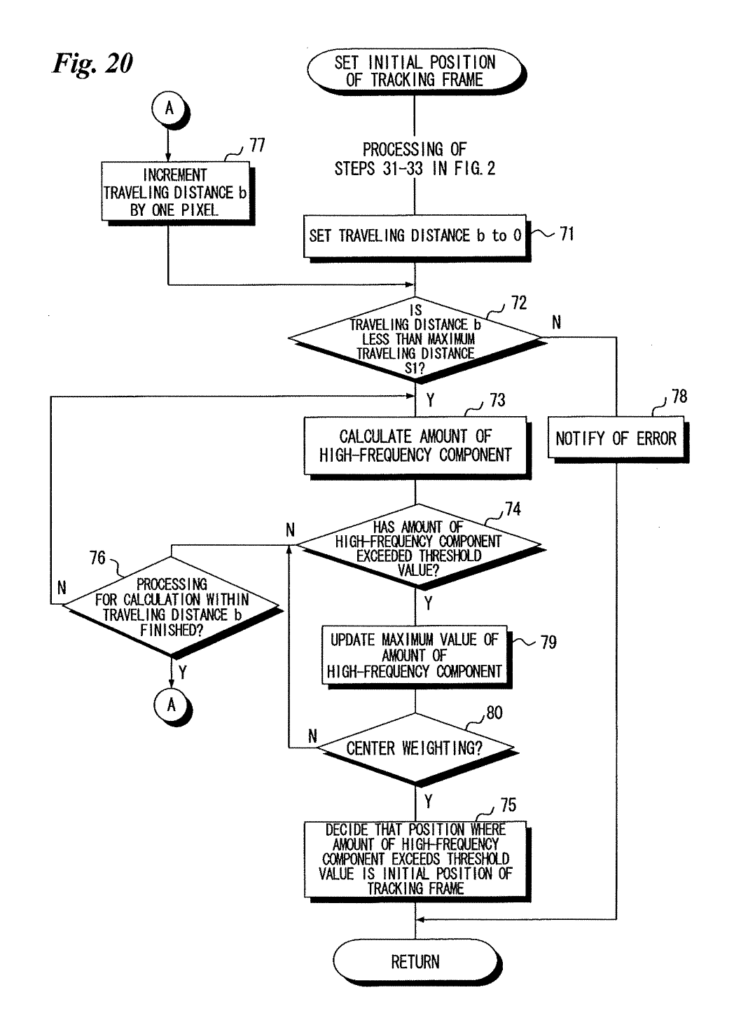

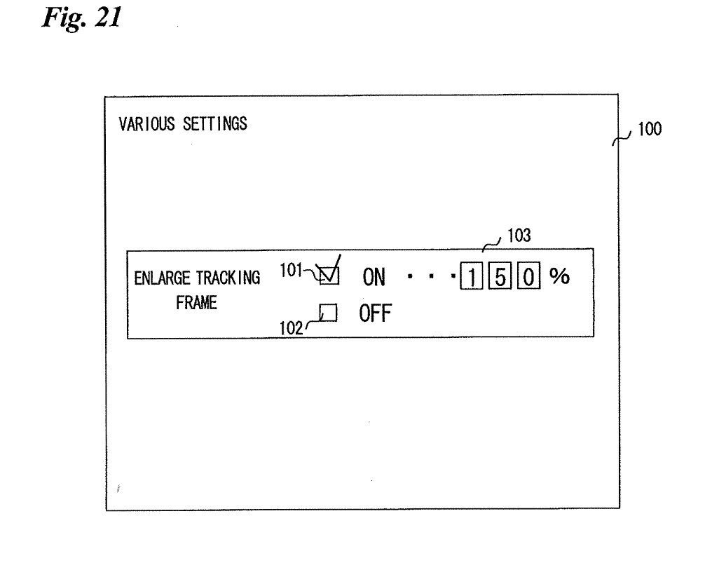

FIGS. 21 to 24 illustrate another embodiment.

FIG. 21 is an example of a menu image for enlarging the tracking frame.

If the menu mode is selected using the mode setting button of the digital still camera and a menu for enlarging the tracking frame is selected from within the menu mode, a menu image 100 (FIG. 21) for enlarging the tracking frame is displayed on the display screen of the display unit 27.

A character string reading “ENLARGE TRACKING FRAME” is displayed substantially at the center of the menu image 100 for enlarging the tracking frame. A first check box 101 and a second check box 102 are displayed to the right of this character string. Characters reading “ON” are displayed to the right of the first check box 101, and characters reading “OFF” are displayed to the right of the second check box 102. An enlargement-rate setting area 103 is displayed to the right of the characters “ON” on the right side of the first check box 101. Numerals are displayed in the enlargement-rate setting area 103. The numerals indicates the enlargement ratio of the tracking frame 41.

Inputting an UP command from the up, down, left, right button places a check in the first check box 101, and inputting a DOWN command from the button places a check in the second check box 102. If, when the first check box 101 has been checked, a RIGHT command is input from the up, down, left, right button, it becomes possible to set the enlargement-rate setting area 103. When the first check box 101 has been checked, the enlargement ratio is raised in response to an UP-command input from the up, down, left, right button, and the enlargement ratio is lowered in response to a DOWN-command input.

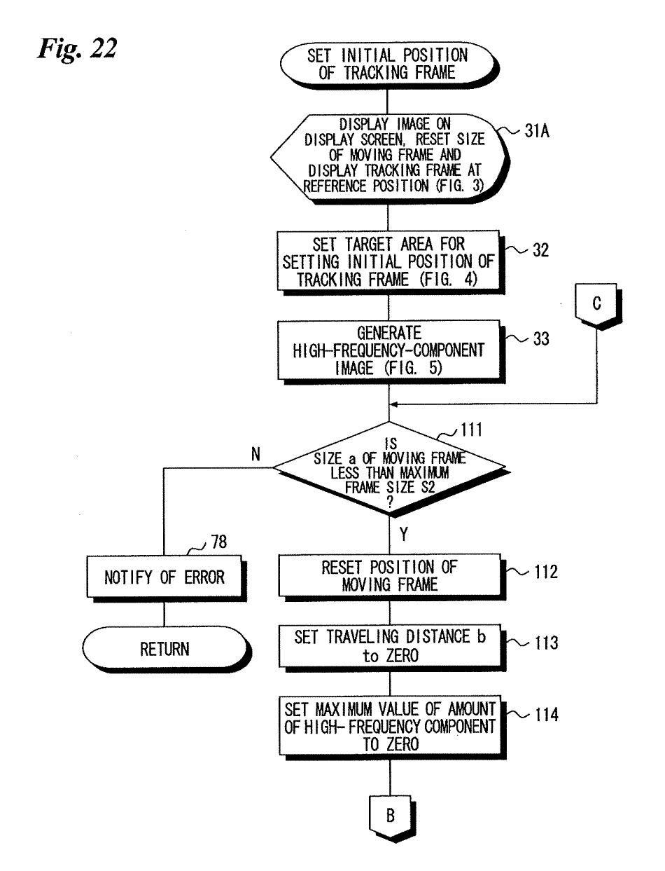

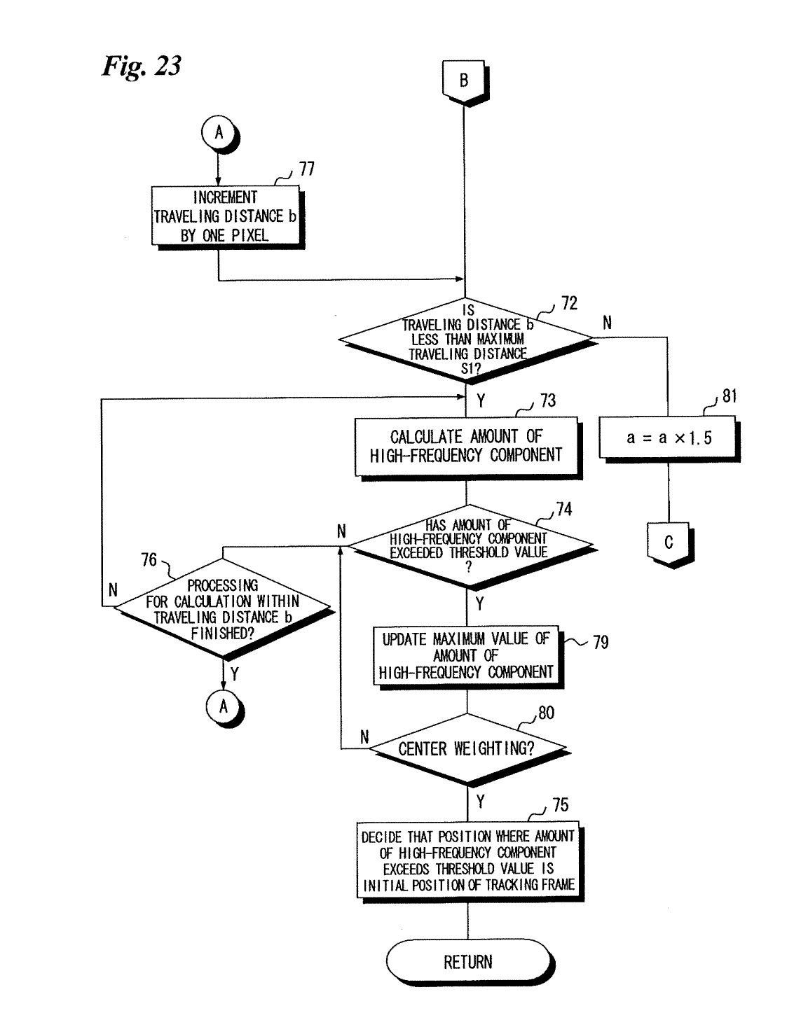

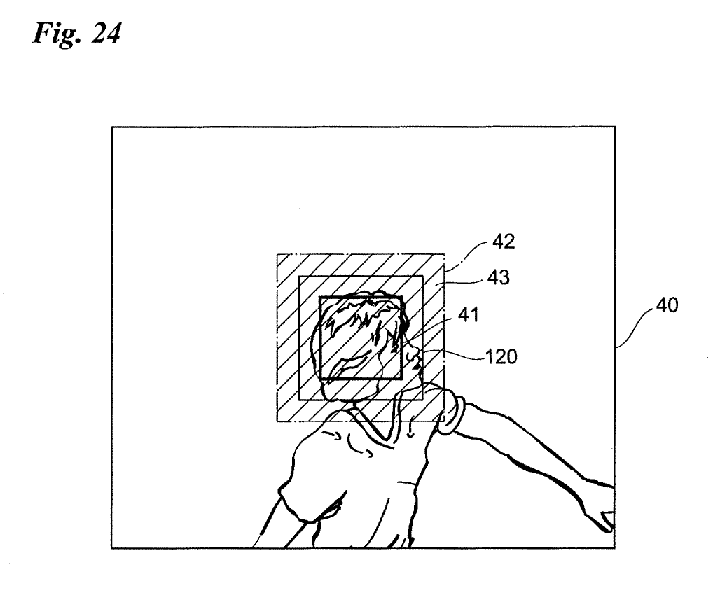

FIGS. 22 and 23 are flowcharts illustrating processing for setting the initial position of the tracking frame. Processing steps shown in FIGS. 22 and 23 identical with those shown in FIG. 20 are designated by like step numbers and need not be described again. FIG. 24 is an example of an image.

This embodiment enlarges the size of the moving frame 41 in accordance with the enlargement ratio set as described above. The size of the moving frame 41 is reset and the tracking frame is displayed at the reference position in the manner described above (step 31A). When the high-frequency-component image is generated as described above (step 33), it is determined whether the size (one side) a of moving frame 41 is less than a maximum frame size S2 (step 111). The maximum frame size S2 decided beforehand to be smaller than the long side or short side of the image 40. For example, S2=4a holds.

If the size a of the moving frame becomes larger than the maximum frame size S2 (“NO” at step 111), notification of an error is given (step 78). If the size a of the moving frame is equal to or less than the maximum frame size S2 (“YES” at step 111), then the position of the moving frame is reset and the moving frame 41 is displayed at the reference position (step 113). Further, the traveling distance b is set to zero (step 113) and the maximum value of the amount of high-frequency component is also set to zero (step 114). As described with reference to FIGS. 17, 18, etc., if the traveling distance b is less than the maximum frame size S2 (“YES” at step S72), the processing for calculating the amount of high-frequency component is repeated while the moving frame 41 is moved outward from the center with the traveling distance b being gradually increased (steps 72 to 80). If the traveling distance b becomes larger than the maximum traveling distance S1 (“NO” at step 72), the size of the moving frame 41 is enlarged to the size that has been set (enlarged moving frame 120) (step 81), as illustrated in FIG. 24. While the enlarged moving frame 120 is moved again, the processing for calculating the amount of high-frequency component is repeated at every position to which the frame is moved.

In a case where the amount of high-frequency component does not exceed the prescribed threshold value, the moving frame 41 is enlarged and, hence, the value of the amount of high-frequency component increases. The value of the amount of high-frequency component comes to exceed the prescribed threshold value and the initial position of the tracking frame 44 can be decided.

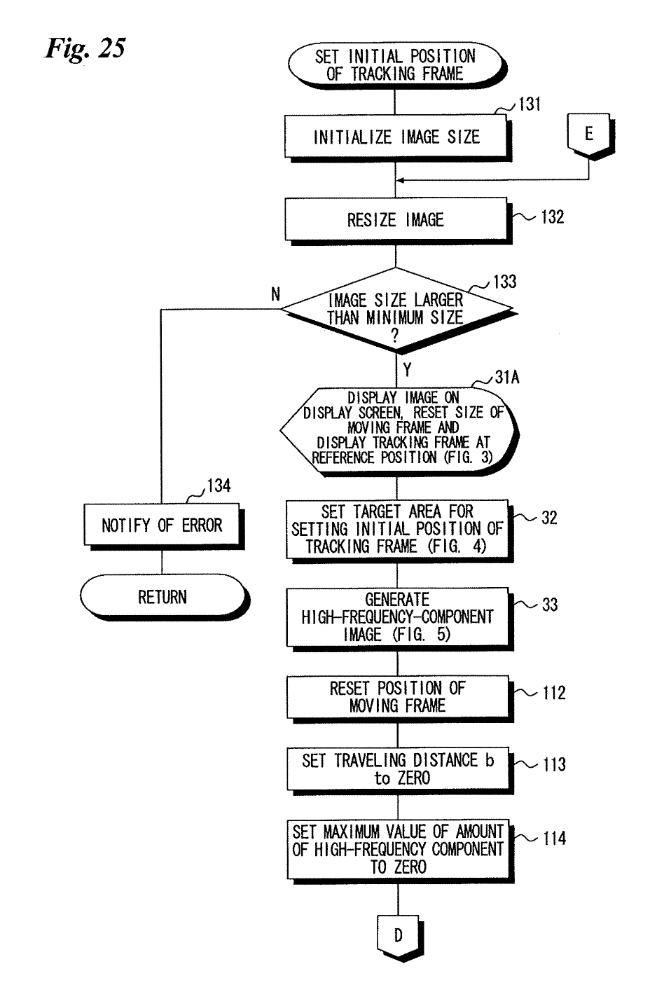

FIGS. 25 to 27 illustrate a further embodiment.

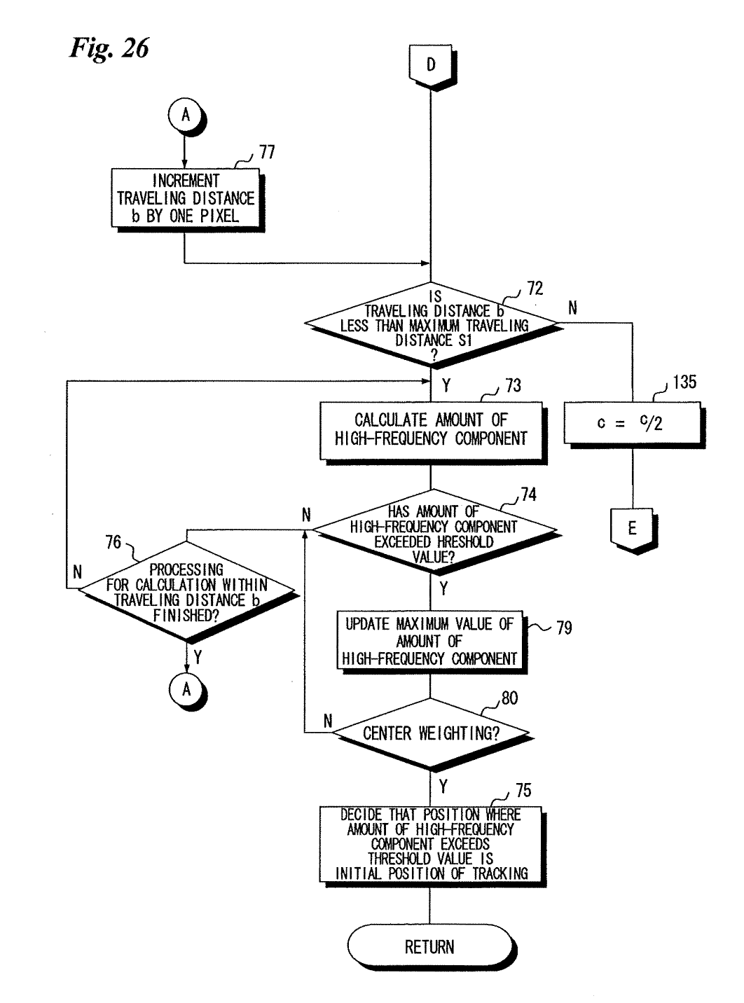

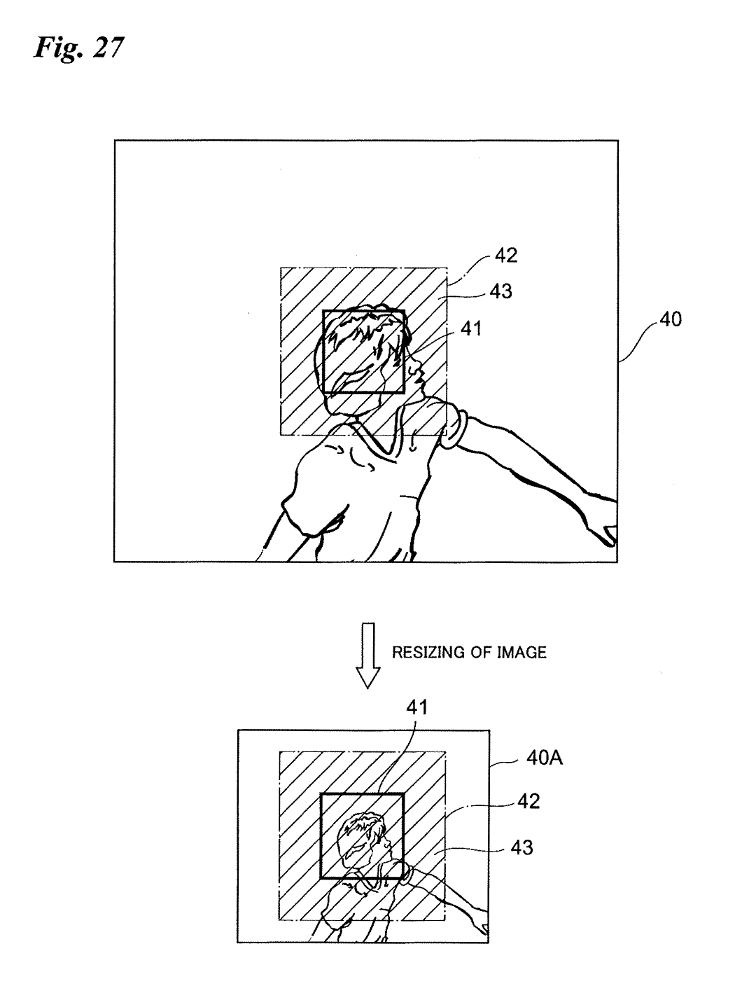

FIGS. 25 and 26 are flowcharts illustrating processing for setting the initial position of the tracking frame. Processing steps shown in FIGS. 25 and 26 identical with those shown in FIGS. 22 and 23 are designated by like step numbers and need not be described again. FIG. 27 is an example of an image.

The size of the moving frame 41 is enlarged in the foregoing embodiment. In this embodiment, however, the size of the one image 40 is reduced. This makes it easier for the amount of high-frequency component to exceed the threshold value in a manner similar to the above case where the size of the moving frame 41 was enlarged.

The size of the one image 40 is initialized to a prescribed size (step 131), as illustrated by the diagram at the top of FIG. 27. Next, the image 40 is resized (step 132). At the start the resize processing is not necessary and may therefore be skipped. In a case where the resizing is performed in such a manner that the image is reduced to less than ⅛ of its original size, it may be so arranged that false-color and false-signal reduction processing is executed.

If image size is not larger than a minimum size (“NO” at step 133), an error notification is given (step 134). If image size is larger than the minimum size (“YES” at step 133), then processing for calculating the amount of high-frequency component within the moving frame 41 is executed (steps 31 to 33, steps 112 to 114, steps 72 to 80, etc.).

In the processing described above, notification of error is given if the traveling distance b exceeds the maximum traveling distance S1 (“NO” at step 72) without the initial position of the tracking frame 44 being decided. In this embodiment, however, image size (the long side or short side of the image 40) c is halved (step 135). As a result, the image 40 is reduced in size to image 40A, as illustrated by the diagram at the bottom of FIG. 27, and processing for calculating the amount of high-frequency component is repeated using the reduced image 40A. It will be understood that since the amount of high-frequency component calculated based upon the image within the moving frame 41 increases, the amount of high-frequency component will exceed the threshold value and the initial position of the tracking frame can be decided.

In the foregoing embodiments, the amount of high-frequency component is calculated while moving the moving frame within a high-frequency-component image obtained by extracting high-frequency components from an image within a target area for setting the initial position of the tracking frame, and the position of the moving frame where an amount of high-frequency component greater than a threshold value or a maximum amount of high-frequency component is obtained is decided upon as the initial position of the tracking frame. However, it may be so arranged that in a case where the amount of high-frequency component is too large (a case where, if the above-mentioned threshold value is made a first threshold value, the amount of high-frequency component exceeds a second threshold value greater than the first threshold value), the processing for calculating the amount of high-frequency component is executed upon generating the high-frequency-component image after the one image is smoothened using a low-pass filter before the high-frequency-component image is generated. If the target image within the tracking frame decided in the processing for deciding the initial position contains too many edge components, there is the possibility that tracking will no longer be achievable owing to just a slight shift in the tracking frame in a case where a target image contained in the image of a subject that is input after the one image is tracked utilizing the target image and template matching, etc. By generating the high-frequency-component image after smoothing is performed and then executing the processing for calculating the amount of high-frequency component, it is possible to prevent an inability to perform tracking owing to just a slight shift in the tracking frame.

In the foregoing embodiments, it is permissible to generate, through use of a low-pass filter or band-pass filter, a low-frequency-component image or an intermediate-frequency-component image of an image within the target area for setting the initial position of the tracking frame, without generating the high-frequency-component-image of the image within the target area for setting the initial position of the tracking frame, and to decide that the position of the moving frame where a large amount of low-frequency component or intermediate-frequency component is obtained is decided upon as the initial position of the tracking frame in a manner similar to that described above. Further, in a case where the frequency band of the target image is known, tracking of the target image will become more accurate by adopting, as the initial position of the tracking frame, the position of the moving frame where the amount of intermediate-frequency component takes on a large value through use of a band-pass filter of the kind that extracts amount of components of the frequency band.

Furthermore, in the foregoing embodiments, rather than generate an image having a specific frequency component from an image within the target area for setting the initial position of the tracking frame, the position of the moving frame where the amount of a set color component (a color component of the target image) takes on a large value may be adopted as the initial position of the tracking frame.

In the foregoing embodiments, the target area for setting the initial position of the tracking frame is set, a high-frequency-component image is generated within this set area and, while the moving frame is moved within the high-frequency-component image generated, the amount of high-frequency component is calculated at every position to which the frame is moved. However, it may be so arranged that the moving frame is moved within the set area without generating the high-frequency-component image, and the amount of high-frequency component of the image within the moving frame is calculated at every position to which the frame is moved.

Further, the tracking frame and the moving frame may be of the same size and shape or may be of different size and shape. For example, in a case where the moving frame is made a rectangular frame having one side a, and tracking frame may be made a rectangular frame having one side 0.8×a.

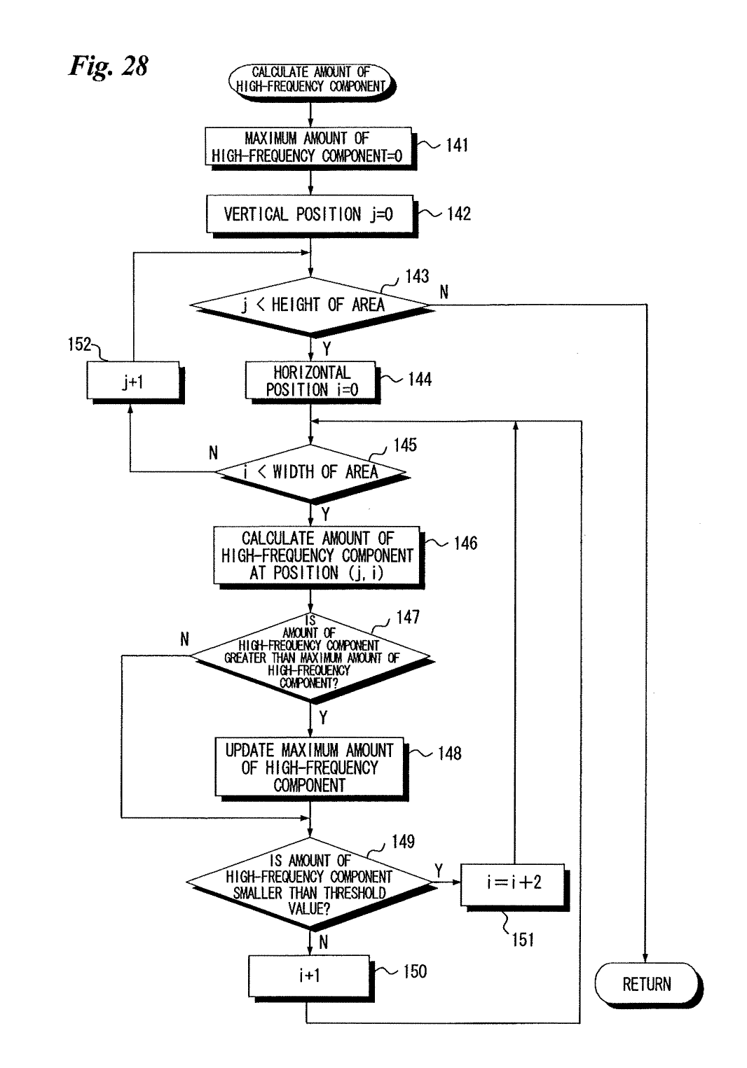

FIG. 28 is a flowchart illustrating processing (e.g., the processing of step 34 in FIG. 2) for calculating amount of high-frequency component while moving the moving frame according to a modification.

In this processing, the moving frame 44 has its traveling distance thus far increased by two pixels if the amount of high-frequency component within the moving frame 44 is less than a prescribed threshold value, and has its traveling distance thus far increased by one pixel if the amount of high-frequency component within the moving frame 44 is greater than the threshold value.

First, the maximum amount of high-frequency component is reset to zero (step 141). Vertical position j of the moving frame is reset to zero (step 142).

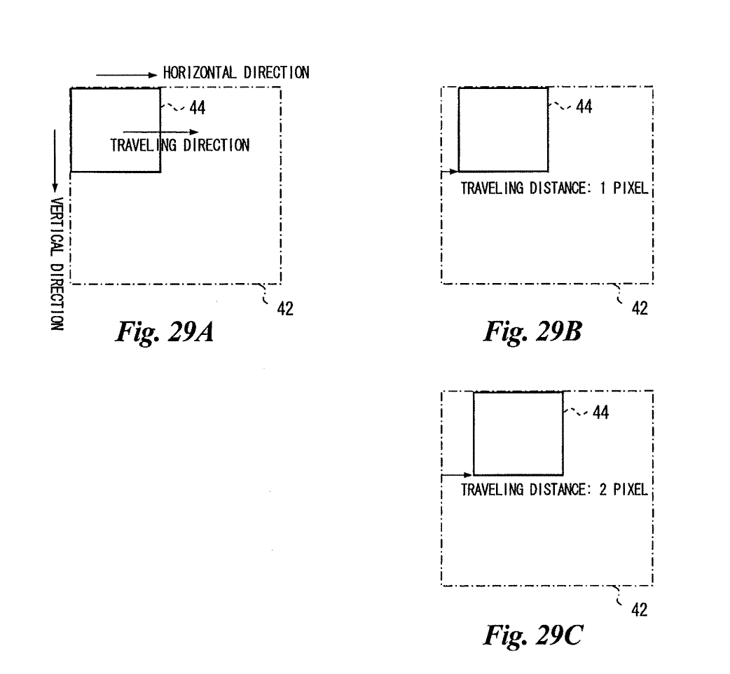

FIG. 29A illustrates the relationship between the moving frame 44 and the target area 42 for setting the initial position of the tracking frame. The coordinates (0,0) of the upper-left corner of the target area 42 for setting the initial position of the tracking frame indicate the origin, the vertical position is j=0 in a case where the moving frame 44 has been positioned at the origin, and the horizontal position is i=0, as will be described later. The position of the moving frame 44 is decided by the vertical position j and horizontal position i.

With reference again to FIG. 28, it is determined whether the vertical position j is smaller than the vertical height (length) of the area 42 defined by the height of the area 42 (step 143). If the vertical position j is smaller than the vertical height (length) of the area 42 (“YES” at step 143), this means that at least a portion of the moving frame 44 is contained in the area 42. Accordingly, the horizontal position i is reset to zero (step 144), then it is determined whether the horizontal position i is smaller than the width (length) of the area 42 in the horizontal direction (step 145). If the horizontal position i is smaller than the length of the area 42 in the horizontal direction (“YES” at step 145), this means that at least a portion of the moving frame 44 is contained within the area 42. Accordingly, the amount of high-frequency component of the image within the moving frame 44 is calculated at the position where the upper-left corner of the moving frame 44 is a position defined by the vertical position j and horizontal position i (step 146).

If the amount of high-frequency component calculated is greater than the maximum amount of high-frequency component (“YES” at step 147), then the amount of high-frequency component calculated is updated to the maximum amount of high-frequency component (step 148).

It is determined whether the amount of high-frequency component calculated is smaller than a prescribed threshold value (step 149). If the amount of high-frequency component calculated is equal to or greater than the prescribed threshold value (“NO” at step 149), the image within the moving frame 44 is in high definition and the traveling distance of the moving frame 44 is made a distance obtained by adding one pixel to the horizontal position i (step 150), as shown in FIG. 29B. If the amount of high-frequency component calculated is smaller than the prescribed threshold value (“YES” at step 149), then the image within the moving frame 44 cannot be construed to be in high definition and the traveling distance of the moving frame 44 is made a distance obtained by adding two pixels to the horizontal position i (step 151), as shown in FIG. 29C. The amount of high-frequency component calculated and the maximum amount of high-frequency component are compared also at the position to which the moving frame 44 has been moved and the traveling distance of the moving frame 44 is decided in accordance with the result of the comparison (steps 145 to 151).

If the value of the horizontal position i is equal to or greater than the length of the area 42 in the horizontal direction (“NO” at step 145), this means that the moving frame 44 has moved out of the area 42 in the horizontal direction and that a portion thereof is no longer contained in the area 42. The position j to which the frame has been moved in incremented in order that the moving frame 44 will be moved in the vertical direction (step 152). If the position j to which the frame has been moved becomes equal to or greater than the height of the area 42, processing ends (“NO” at step 143).

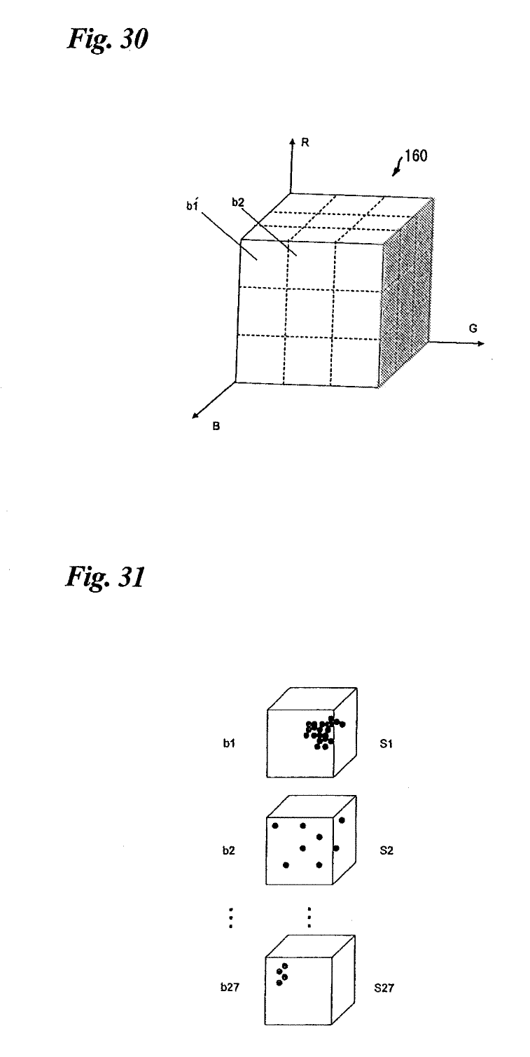

FIGS. 30 and 31 illustrate a modification. This modification utilizes a distribution of color components in color space in a case where the initial position of the tracking frame 41 is decided utilizing color components.

FIG. 30 illustrates RGB color space (which may be another color space such as CrCb color space).

Consider a space 160 delimited by (0,0,0), (0,255,0), (0,0,255), (0,255,255), (255,0,0), (255,0,255) and (255,255, 255). The space 160 is divided into three equal portions (but not necessarily three equal portions) along each coordinate axis so as to form a total of 27 small blocks b1 to b27.

The moving frame 44 is moved within the target area 42 for setting the initial position of the tracking frame, as mentioned above, and the number of pixels within the moving frame 44 is plotted in the color space of FIG. 30 at every position to which the frame is moving frame is moved. Plotted numbers S1 to S27 of pixels are calculated in respective ones of the small blocks b1 to b27, as illustrated in FIG. 31. The largest number of pixels among the calculated numbers S1 to S27 of pixels is detected as a maximum pixel count Smax at the position to which the moving frame has been moved.

The processing for calculating the maximum pixel count Smax is executed at every position to which the moving frame 44 is moved and the position having the largest value among the values of the maximum pixel count Smax at each of the positions to which the frame has been moved is decided upon as the initial position of the tracking frame.

As many apparently widely different embodiments of the present invention can be made without departing from the spirit and scope thereof, it is to be understood that the invention is not limited to the specific embodiments thereof except as defined in the appended claims.

What is claimed is:

1. A tracking-frame initial-position setting apparatus in a target-image automatic tracking system for inputting, in order frame by frame, image data representing a number of frames of images, and displaying, on a display screen of a display unit, a tracking frame enclosing a target image to be tracked included in the images represented by the image data that has been input, said apparatus comprising:
a display control device for controlling the display unit so as to display one image, which is represented by the image data that has been input to the target-image automatic tracking system, on the display screen, and display the tracking frame at a reference position on the display screen;
a target-area setting device for setting, on the one image, a tracking-frame initial-position setting target area having a size larger than the tracking frame displayed at the reference position under the control of said display control device and smaller than the one image, the target area containing the tracking frame displayed at the reference position under the control of said display control device;
a specific frequency component amount calculating device for moving a moving frame in the image within the initial-position setting target area that has been set by said target-area setting device, and calculating amount of high-frequency component of the image within the moving frame whenever the moving frame is moved; and
a deciding device for deciding that a position of the moving frame where the amount of high-frequency component calculated by said specific frequency component amount calculating device exceeds a prescribed threshold value or is maximum is the initial position of the tracking frame.

2. The apparatus according to claim 1, wherein image data that is input to the target-image automatic tracking system is color image data, and said apparatus further comprises a color component amount calculating device for moving the moving frame within the image inside the initial-position setting target area that has been set by said target-area setting device, and calculating amount of component of a prescribed color component of the image within the moving frame whenever the moving frame is moved;
said deciding device deciding that the position of the moving frame where the amount of component calculated by said color component amount calculating device exceeds a prescribed threshold value or is maximum is the initial position.

3. The apparatus according to claim 1, further comprising a first control device for controlling said specific frequency component amount calculating device so as to execute processing for calculating the amount of high-frequency component upon enlarging the moving frame in response to the amount of high-frequency component calculated by said specific frequency component amount calculating device failing to exceed the prescribed threshold value.

4. The apparatus according to claim 1, further comprising a second control device for controlling said color component amount calculating device so as to execute processing for calculating the amount of color component upon enlarging the moving frame in response to the amount of color component calculated by said color component amount calculating device failing to exceed the prescribed threshold value.

5. The apparatus according to claim 3, further comprising an enlarge commanding device for applying a moving-frame enlargement command;
wherein said first control device controls said specific frequency component amount calculating device so as to execute the processing for calculating the amount of high-frequency component upon enlarging the moving frame in response to application of the enlargement command from said enlarge commanding device and, moreover, the amount of high-frequency component calculated by said specific frequency component amount calculating device failing to exceed the prescribed threshold value.

6. The apparatus according to claim 4, further comprising an enlarge commanding device for applying a moving-frame enlargement command;
wherein said second control device controls said color component amount calculating device so as to execute the processing for calculating the amount of color component upon enlarging the moving frame in response to application of the enlargement command from said enlarge commanding device and, moreover, the amount of color component calculated by said color component amount calculating device failing to exceed the prescribed threshold value.

7. The apparatus according to claim 3, further comprising an enlargement ratio setting device for setting an enlargement ratio of the moving frame;
wherein said first control device controls said specific frequency component amount calculating device so as to execute the processing for calculating the amount of high-frequency component upon enlarging the moving frame in accordance with the enlargement ratio, which has been set by said enlargement ratio setting device, in response to application of the enlargement command from said enlarge commanding device and, moreover, the amount of high-frequency component calculated by said specific frequency component amount calculating device failing to exceed the prescribed threshold value.

8. The apparatus according to claim 6, further comprising an enlargement ratio setting device for setting an enlargement ratio of the moving frame;
wherein said second control device controls said color component amount calculating device so as to execute the processing for calculating the amount of color component upon enlarging the moving frame in accordance with the enlargement ratio, which has been set by said enlargement ratio setting device, in response to the amount of color component calculated by said color component amount calculating device failing to exceed the prescribed threshold value.

9. The apparatus according to claim 1, further comprising a third control device for controlling said specific frequency component amount calculating device so as to execute the processing for calculating the amount of high-frequency component upon reducing the size of the one image in response to the amount of high-frequency component calculated by said specific frequency component amount calculating device failing to exceed the prescribed threshold value.

10. The apparatus according to claim 2, further comprising a fourth control device for controlling said color component amount calculating device so as to execute the processing for calculating the amount of color component upon reducing the size of the one image in response to the amount of color component calculated by said color component amount calculating device failing to exceed the prescribed threshold value.

11. The apparatus according to claim 1, further comprising a first notification device for giving notification that tracking processing cannot be executed in response to the amount of high-frequency component calculated by said specific frequency component amount calculating device failing to exceed the prescribed threshold value.

12. The apparatus according to claim 2, further comprising a second notification device for giving notification that tracking processing cannot be executed in response to the amount of color component calculated by said color component amount calculating device failing to exceed the prescribed threshold value.

13. The apparatus according to claim 11, wherein said first notification device gives notification that tracking processing cannot be executed by a voice output or a by change in form of the display of the tracking frame.

14. The apparatus according to claim 11, wherein said first notification device gives notification that tracking processing cannot be executed by a change in the color, type of line or shape of the tracking frame, or by a change in method of lighting or flashing the tracking frame.

15. The apparatus according to claim 12, wherein said second notification device gives notification that tracking processing cannot be executed by a voice output or by a change in form of the display of the tracking frame.

16. The apparatus according to claim 12, wherein said second notification device gives notification that tracking processing cannot be executed by a change in the color, type of line or shape of the tracking frame, or by a change in method of lighting or flashing the tracking frame.

17. The apparatus according to claim 1, wherein said target-area setting device sets the tracking-frame initial-position setting target area on the one image in such a manner that the reference position will be at the center;
said specific frequency component amount calculating device moving the moving frame outward from the reference position and calculating the amount of high-frequency component of the image within the moving frame whenever the moving frame is moved.

18. The apparatus according to claim 2, wherein said target-area setting device sets the tracking-frame initial-position setting target area on the one image in such a manner that the reference position will be at the center;
said color component amount calculating device moving the moving frame outward from the reference position and calculating the amount of component of the prescribed color component of the image within the moving frame whenever the moving frame is moved.

19. The apparatus according to claim 1, wherein said specific frequency component amount calculating device moves the moving frame and calculates amount of low-frequency component, or amount of intermediate-frequency component from which high-frequency components have been eliminated, of the image within the moving frame whenever the moving frame is moved; and
said deciding device decides that a position of the moving frame where the amount of low-frequency component or amount of intermediate-frequency component calculated by said specific frequency component amount calculating device exceeds a prescribed threshold value is the initial position of the tracking frame.

20. The apparatus according to claim 1, further comprising a noise reduction processing device for applying noise reduction processing to the image data representing the one image;
wherein the one image represented by the image data that has been subjected to the noise reduction processing by said noise reduction processing device is subjected to processing by said target-area setting device, processing by said specific frequency component amount calculating device and processing by said deciding device.

21. The apparatus according to claim 1, further comprising a signal processing device for applying false-color or false-signal reduction processing to the image data representing the one image;
wherein the one image represented by the image data that has been subjected to the false-color or false-signal reduction processing by said signal processing device is subjected to processing by said target-area setting device, processing by said specific frequency component amount calculating device and processing by said deciding device.

22. The apparatus according to claim 1, further comprising a halt commanding device for applying a command that halts processing for deciding the initial position of the tracking frame;
wherein in response to application of the halt command from said halt commanding device, processing by said target-area setting device, processing by said specific frequency component amount calculating device and processing by said deciding device is halted and the reference position is decided upon as the initial position of the tracking frame.

23. A method of controlling operation of a tracking-frame initial-position setting apparatus in a target-image automatic tracking system for inputting, in order frame by frame, image data representing a number of frames of images, and displaying, on a display screen of a display unit, a tracking frame enclosing a target image to be tracked included in the images represented by the image data that has been input, the method comprising the steps of:
controlling the display unit so as to display one image, which is represented by the image data that has been input to the target-image automatic tracking system, on the display screen, and display the tracking frame at a reference position on the display screen;
setting, on the one image, a tracking-frame initial-position setting target area having a size larger than the tracking frame displayed at the reference position and smaller than the one image, the target area containing the tracking frame displayed at the reference position;
moving a moving frame in the image within the initial-position setting target area that has been set, and calculating amount of high-frequency component of the image within the moving frame whenever the moving frame is moved; and
deciding that a position of the moving frame where the amount of high-frequency component calculated exceeds a prescribed threshold value or is maximum is the initial position of the tracking frame.
